(19) United States
(12) Patent Application Publication
(10) Pub. No.: US 2008/0163133 A1
(43) Pub. Date: Jul. 3, 2008

(54) Sophisticated sort mechanisms on a limited interface

(75) Inventors: Gregory A. Martinez, Seattle, WA (US); Steven R. Gunn, Bellevue, WA (US); Paolo V. Malabuyo, Bothell, WA (US); Vadim Gorokhovsky, Redmond, WA (US); Thamer Abanami, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/648,202

(22) Filed: Dec. 29, 2006

(51) Int. Cl. G06F 3/14

(52) U.S. Cl. 715/864

(57) ABSTRACT

Entertainment devices often display interfaces that are perceived from a distance. To render the interface intelligible at a distance, a limited interface is used. However, often the user is presented with a large number of choices, which can be tedious and time-consuming to review using such a limited interface. The selection from among multiple sorting mechanisms, all from within a single screen, can enable the user to quickly sort, in the manner most appropriate for that user, the available choices. If the sorting order results in the relevant choices being listed last, a reverse sort option can be used, again from within the same screen.

### BACKGROUND

The convergence of consumer entertainment devices and computers has long been predicted. Indeed, consumer entertainment devices have long shared similar hardware elements with computers, including central processing units and computer-readable storage media, such as optical disks and Read-Only Memory (ROM). More recently, a convergence of software has likewise occurred, whereby some computer software has sought to perform functions traditionally performed by consumer electronic devices, such as playing pre-recorded audio or video content and some consumer electronic devices have incorporated software that performs functions traditionally reserved for computers, such as Web browsing or emailing.

The manner in which they are traditionally used, however, does limit the extent to which consumer electronic devices and computers can converge. While a computer is traditionally accessed via a mouse and keyboard, consumer entertainment devices are traditionally accessed via remote controls that often have significantly less keys and other data entry mechanisms than a common computer keyboard. Similarly, computers are often used with displays that are located proximally to the user, while consumer electronics devices are often used at some distance from the user. Consequently, a computer can display a greater amount of information which can be easily perceived by the user, while a consumer electronic device may limit the quantity of information displayed because the ability of the consumer to perceive the information at a distance may be limited.

As a result, while computers and consumer electronic devices have some overlap in their functions, the interface presented to a user when performing those functions can differ. For example, both computers and consumer electronics devices now comprise the capability to download audio and video entertainment from remote locations and present it to the user. Likewise, both computers and consumer electronic devices now comprise the capability to select specific audio and video entertainment that is to be recorded at a subsequent time when it is broadcast by a content delivery provider, such as a cable or satellite television provider. However, a computer allows the user to select such audio and video entertainment in an efficient manner because of greater quantity of information that can be displayed to the user and because the user can use a keyboard and mouse to efficiently browse that information and quickly identify and information that is relevant to the user's needs.

### SUMMARY

Many consumer entertainment remote controls have only a few buttons or similar user input elements. To efficiently select from among many choices, sorting mechanisms can be used to reduce the number of choices or otherwise reorder the choices to first present the choices that are most relevant to the user. Common sorting mechanisms include mechanisms based on popularity, date, title, genre and the like. In one embodiment, sorting mechanisms can be selected by buttons commonly found on remote controls, such as left and right arrow buttons. In an alternative embodiment, only a single button can be used to select sorting mechanisms presented in a circular fashion.

Even when properly sorted, a many choices may still remain. More problematically, the choices that the user may be interested in may be located at the end of even a properly sorted list. For example, when the user already knows the name or title of the choice they seek, an alphabetical sorting mechanism can be useful. However, if the name or title begins with a letter like “Z”, the user will be forced to scroll through the entire listing to reach their desired choice. Consequently, in one embodiment, the selection of sorting mechanisms can be combined with a “reverse sort” option, whereby the ordering of the choices by the currently selected sorting mechanism can be reversed to provide more efficient access to those choices sorted near the end. The selection of a reverse sort can be accomplished though a single button on a remote control.

Many consumer electronics devices present user interfaces within the context of “screens” or collections of data designed to fill the display area of the display device to which the consumer electronic device is connected. The user's selection of various choices takes place within the context of these screens. For example, one screen can present choices sorted using one sorting mechanism, while a second screen can be selected to receive choices sorted using a different sorting mechanism. By enabling the user to select from among different sorting mechanisms via one or two buttons, and by providing single button access to reverse sort the currently selected sorting mechanism, the user can remain on a single screen and merely change the sorting of the choices to provide of efficient access to the choices that are relevant for that user. Consequently, the time and computing effort in redrawing multiple screens is avoided, as is the potential frustration by the user of continually being forced to select multiple screens.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a diagram of an exemplary audio-visual entertainment system that provides context for the described functionality;

FIG. 2 is a block diagram of an exemplary computing device;

FIG. 3 is an example of a limited user interface illustrating one aspect of an enhanced sorting mechanism;

FIG. 4 is an example of a limited user interface illustrating another aspect of an enhanced sorting mechanism; and

FIG. 5 is an example of a limited user interface illustrating another aspect of an enhanced sorting mechanism.

### DETAILED DESCRIPTION

The following description relates to providing users with the ability to efficiently locate and select a choice from among a myriad of choices through an interface presented at a distance. More specifically, the following description relates to providing users with the ability to resort choices without requiring the user to select a new “screen.” Traditionally, interfaces that are viewed from a distance can only present a limited amount of information that can be meaningfully recognized by the user. Such information is often presented within the context of a “screen,” or a collection of information that is designed to cover all, or substantially all, of the viewing area of the display device through which the interface is being presented to the user. By enabling users to resort choices within a single screen, the user can more efficiently locate and select those choices that are of relevance to the user without the inefficiency and frustration introduced by selecting further screens.

The techniques described herein focus on the selection of multiple sorting mechanisms via one or two keys or other user input elements on a remote control device. In one embodiment, the selection of sorting mechanisms can be implemented by two keys, enabling the user to toggle back and forth between sorting mechanisms. In an alternative embodiment, the selection of sorting mechanisms can be presented to the user in a circular manner, facilitating the selection of such sorting mechanisms using only a single key. A still further embodiment contemplates that the order in which any selected sorting mechanism presents the various options can be reversed via a single key.

Although not required, the description below will be in the general context of instructions being executed by a device having computational abilities. Such “computing devices” include both traditional computers and consumer-electronic devices having computational abilities, such as those provided by a central processing unit. Thus, the description below will be in the general context of “computer-executable instructions,” such as program modules, that are capable of being executed by a such a “computing device.” More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers and conventional personal electronics devices, and can include other devices capable of computation, including hand-held devices, multi-processor systems, other microprocessor based or programmable consumer electronics, network PCs, minicomputers, mainframe computers, and the like. Similarly, the computing devices need not be limited to a stand-alone device, as the mechanisms may also be practiced in distributed computing environments where tasks are performed by remote processing devices that are linked through a communications network. In a distributed computing environment, program modules may be located in both local and remote memory storage devices.

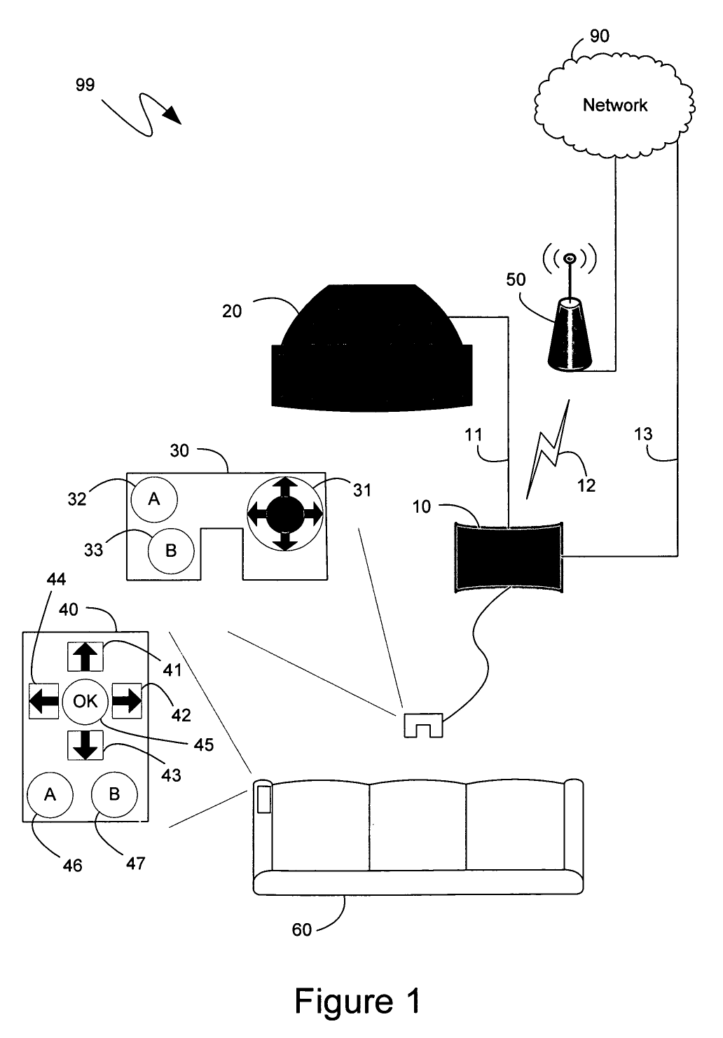

With reference to FIG. 1, an exemplary audio-visual entertainment system 99 is illustrated, providing context for the descriptions below. Exemplary system 99 includes a computing device 10 which is illustrated as, but is not limited to, a consumer entertainment device. The computing device 10 is connected to a display device 20 via a connection 11. As will be recognized by those skilled the art, the display device 20 can include both visual and audio delivery mechanisms and, consequently, the connection 11 can include both a video connection and an audio connection. The computing device 10 is likewise connected to a network 90 via either a wired connection 13 or a wireless connection 12 to a wireless base station 50 which can then be connected to the network 90 via a wired connection. As will be explained in greater detail below, the network 90 can serve as the source for some or all of the content displayed on the display device 20 via the computing device 10.

The computing device 10 can be controlled by remote controls 30 or 40. Remote control 30 can be either a wired or wireless remote control, such as is used by video game consoles, while remote control 40 can be a wireless remote control, such as an infra-red remote control used by many consumer entertainment devices. Each of the remote controls 30 and 40 comprises buttons 31-33 and 41-47, respectively. Wired remote control 30 comprises a control pad 31, which can be a joystick, thumb pad, D-pad or similar multi-directional input device. The control pad 31 comprises the ability to accept input in both the vertical and horizontal direction and the ability to accept a selection input by via downward pressure applied to the middle of the control pad 31. The wired remote control 30 further comprises two selection buttons 32 and 33, generically labeled “A” and “B,” respectively, in FIG. 1. The wireless remote control 40 comprises individual buttons 41, 42, 43 and 44 for selecting one of the four directions: up, right, down and left, respectively. The wireless remote control 40 likewise comprises a selection button 45 and two other selection buttons 46 and 47, generically labeled “A” and “B,” respectively, in FIG. 1. As will be recognized by those skilled in the art, the collection of buttons 41-45 serves a similar function to the control pad 31 and either remote control 30 or 40 could have either a collection of buttons, such as buttons 41-45, or a control pad, such as control pad 31.

The remotes 30 and 40 enable a user to access and instruct the computing device 10 at a distance. The display 20 is often located some distance from the user's location, represented in FIG. 1 by the seating surface 60. Because the connection 11 between the computing device 10 and the display 20 is likely a wired connection wherein the quality of the connection 11 degrades with distance, the computing device 10 is often located proximate to the display 20 and, thus, away from the user. And while many types of wireless input devices exist for enabling a user to control a computing device 10 located at some distance from the user, including wireless keyboards and wireless mice, remotes 30 and 40 represent the simplified remotes typically associated with consumer entertainment devices that comprise only a limited number of buttons or user input elements.

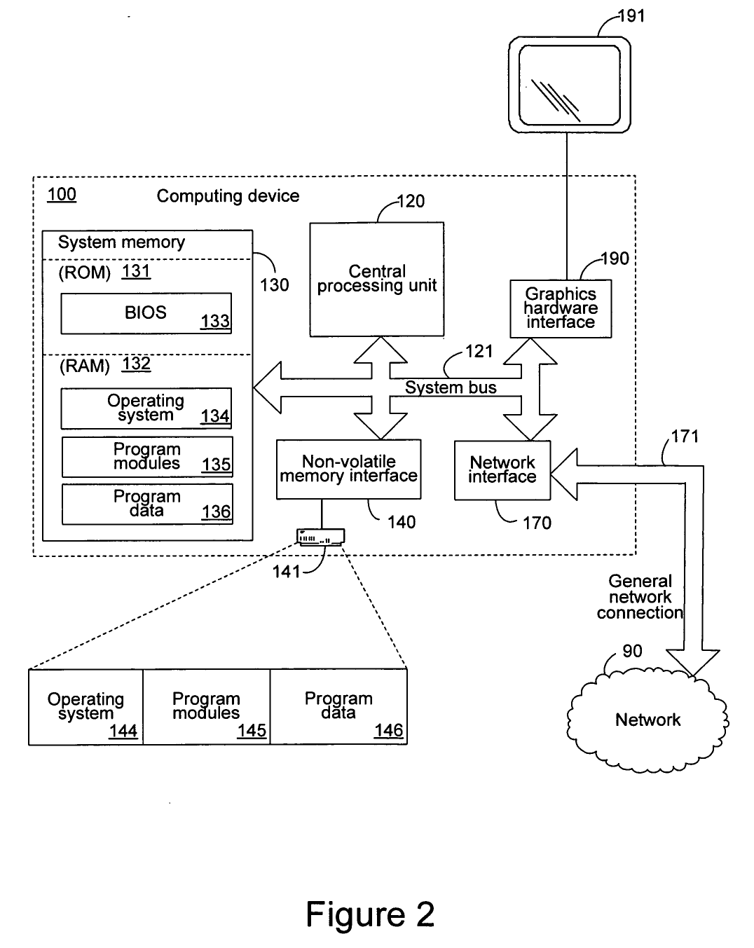

Turning to FIG. 2, an exemplary computing device 100 is illustrated. As indicated previously, the term “computing device,” as used herein, includes consumer entertainment devices, such a video game consoles, digital video recorders, and content provider interfaces such as the ubiquitous “cable box.”

The exemplary computing device 100 can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. The computing device 100 can include graphics hardware, including, but not limited to, a graphics hardware interface 190 and a display device 191.

The computing device 100 also typically includes computer readable media, which can include any available media that can be accessed by computing device 100 and includes both volatile and nonvolatile media and removable and non-removable media. By way of example, and not limitation, computer readable media may comprise computer storage media, communication media or combinations thereof. Computer storage media includes media implemented in any method or technology for storage of information such as computer readable instructions, data structures, program modules or other data. Communication media typically embodies computer readable instructions, data structures, program modules or other data in a modulated data signal such as a carrier wave or other transport mechanism and includes any information delivery media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, other program modules 135, and program data 136.

The computing device 100 may also include other removable/non-removable, volatile/nonvolatile computer storage media. By way of example only, FIG. 2 illustrates a hard disk drive 141 that reads from or writes to nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through an interface such as non-volatile memory interface 140.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing operating system 144, other program modules 145, and program data 146. Note that these components can either be the same as or different from operating system 134, other program modules 135 and program data 136. Operating system 144, other program modules 145 and program data 146 are given different numbers hereto illustrate that, at a minimum, they are different copies.

Of relevance to the descriptions below, the computing device 100 may operate in a networked environment using logical connections to one or more remote computers. For simplicity of illustration, and in conformance with the exemplary system 99 of FIG. 1, the computing device 100 is shown in FIG. 2 to be connected to the network 90. The computing device 100 is not limited to any particular network or networking protocols. The network connection depicted in FIGS. 1 and 2 is a general network connection 171 that can be a local area network (LAN), a wide area network (WAN) or other networks. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

The connection to the network 90 can enable the computing device 10 of FIG. 1 to obtain audio and video entertainment from a myriad of sources that are likewise connected to the network 90. For example, one or more servers connected to the network 90 can offer, for download by the computing device 10, audio and video entertainment, such as movies, television shows, songs, radio or other audio broadcasts, and other audio or video digital files. Once downloaded, at least in part, to the computing device 10, the audio and video can be displayed to the user, such as through the display 20.

Before being downloaded, however, the audio and video entertainment can first be selected by the user for download from among a listing of some or all of the audio and video entertainment offered by the one or more servers connected to the network 90. Often, the user may know the name or title of the entertainment file the user seeks to download. In such a case, a keyboard interface could be useful to enable the user to simply type in the relevant terms into a search field. However, a keyboard can be a very cumbersome device when compared to more traditional remote controls. If the user wishes to control the computing device 10 through simpler devices, such as the remote controls 30 and 40, a more brute force approach can be used to enable the user to select the entertainment the user desires. More specifically, all of the entertainment offered for download that matches some criteria can be listed to enable the user to select the entertainment they desire. However, because the complete list is often not locally available, the computing device 10 may need to download it a section at a time from the server. Consequently, traditional fast scrolling mechanisms cannot be used, and the user is forced to tediously scroll through a potentially long list of entertainment choices.

The user can face similar difficulties even if they do not know, in advance, the name or title of the entertainment choice they desire, and instead are merely browsing the available entertainment choices. Specifically, while such a scenario may not benefit from the greater control provided by a full keyboard and mouse input system, the user will still be limited in their ability to scroll through a long list of choices by the need for the computing device to download one section of the list at a time from the server hosting the entertainment choices.

Traditionally, entertainment choices are presented by the computing device 10 to the user via “screens,” or an arrangement of display elements that consumes substantially all of the display area of display 20. A screen can provide the user with a list of choices that the user can scroll through, subject to the above described scrolling limitations. To avoid presenting the user with a list of choices that is too long to efficiently scroll through, the computing device 10 can provide the user with the option of resorting the list via different screens. For example, an alphabetical sorting of entertainment choices can be presented to the user by one screen and a date sorting can be presented to the user by another screen. more specifically, various sorting mechanisms can be presented to the user as options in a “main” screen. A selection of any option at that screen can cause the presentation of a different screen that provides the entertainment choices sorted in the selected method. To transition to another sorting mechanism, the user first must return to the main screen and subsequently select a different sorting option.

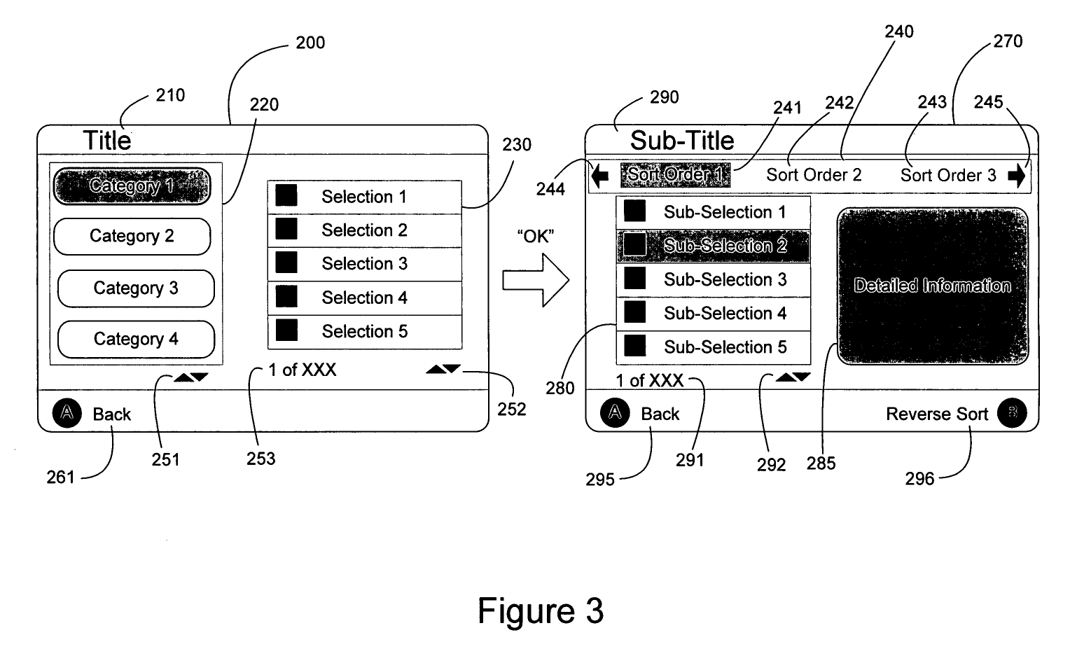

Turning to FIG. 3, a limited user interface that enables a user to sort options from within a single screen is shown. By enabling the sorting of options from within a single screen, the limited user interfaces described below enable a user to efficiently select from among a myriad of entertainment choices without: (1) requiring the use of a bulky and impractical keyboard and mouse control system, (2) forcing the user to wait for continuous updates of the list from the server so as to scroll through the list of choices to reach the choice they desire and (3) forcing the user to return to a main screen in order to select another sorting option.

In FIG. 3, screen 200 can represent either a main screen or a sub-screen where the user can be presented with various choices. If the screen 200 was a main screen, the title 210 can reflect such a status by indicating that screen 200 provides all of the available entertainment options. Likewise, if the screen 200 was a main screen, categories 220 could be broad characterizations of the type of entertainment options offered. For example, on a main screen, the categories 220 could be: “TV Shows,” “Movies,” “Music” and the like. The selections 230 could be similarly appropriate for a main screen, such as showing the most popular downloads. Screen 200 need not, however, represent a main screen, and can, instead, represent a sub-screen, as would be evidenced by the title 210 and the categories 220 offered by screen 200. For example, if the screen 200 was a sub-screen, the title 210 could indicate a specific type of entertainment option, such as “TV Shows,” or “Movies.” Likewise, the categories 220 could indicate various genres, such as “Drama” or “Comedy.” Alternatively, categories 220 could indicate preliminary sorting options, such “Alphabetically,” “By Release Date” and the like. Again, the selections 230 can be commensurate with the status of screen 200 as a sub-screen.

The categories 220 may comprise more entries than can be fit onto the screen 200. In such a case the presence of arrows 251 indicates that additional categories may exist. As will be known by those skilled the art, categories 220 can be scrolled through via “up” or “down” arrows on a remote, such as the keys 41 and 43 of remote 40, or such as the appropriate sections of control pad 31 of remote 30. Thus, the presence of arrows 251 can indicate that additional categories may be accessed by continuing to scroll up or down beyond the categories 220 shown. Arrows 252 can likewise indicate the presence of additional selections beyond the selections 230 shown. Because the number of selection can be quite large, a paginating element 253 can inform the user of the overall number of selections by indicating the current selection, or current screenful of selections, as compared to the total selections or screenfuls of selections.

Special buttons, such as buttons 32 and 33 of remote control 30, and buttons 46 and 47 of remote control 40 can be assigned specific functions via indicators at the bottom of the screen, such as indicator 261, which specifies the button to be used to select a prior screen.

In addition to illustrating screen 200, FIG. 3 likewise illustrates screen 270, which can be accessed by the user from screen 200 by highlighting a category from among categories 220, as shown, highlighting a selection from among selections 230, as shown, and then inputting a selection indication, such as by pressing the “OK” button as indicated by the transitional arrow between screens 200 and 270.

Screen 270, therefore, indicates that the highlighted “Selection 3” becomes the title 290 of screen 270 and that additional sub-selections 280 that may be relevant to “Selection 3” can be presented to the user. A paginating element 291 can provide information regarding the overall quantity of sub-selections 280 available, analogously to the paginating element 253 of screen 200 described above. Likewise, arrows 292 can, in the same manner as arrows 251 and 252, indicate the presence of additional sub-sections beyond the sub-sections 280 shown. In addition, screen 270 further comprises a detailed information section 285 that can provide further information regarding a highlighted sub-selection.

Screen 270 also illustrates the display of various sorting options 240, generically entitled “Sort Order 1” 241, “Sort Order 2” 242 and “Sort Order 3” 243. While the space available may be limited, the titles of sorts 241, 242 and 243 can be selected to be as descriptive as possible. The currently selected sorting option, namely sorting option 241 in FIG. 3, can be indicated via highlighting or other visual or auditory representation. The availability of additional sorting options, such as sorting options 242 and 243, can be indicated by grayed-out text or other visual or auditory cue to signify their availability, but non-selection. In one embodiment, the available sorting options, such as sorting options 242 and 243 always appear to either the left, as shown, or to the right of the selected sorting option, such as sorting option 241. In another embodiment, the selected sorting option can move within the list of sorting options 240. In yet another embodiment, the sorting options 240 can be presented in the form of a circular list, such that continued scrolling past the last sorting option returns to the first sorting option.

Selection of the sorting options 240 can be accomplished via the buttons specified by the selection indicators 244 and 245. In the exemplary screen 270 shown in FIG. 3, the selection indicators 244 and 245 comprise left and right arrows, respectively, thereby corresponding to buttons 44 and 42, respectively of remote 40 and to the appropriate selections via the control pad 31 of remote 30. In an alternative embodiment, the sorting options 240 can be presented in a circular list and only a single selection indicator can be used. As will be described in further detail below, the selection of the sorting options 240 can be performed from within a screen, such as screen 270.

The initially selected sorting option, such as sorting option 241 in screen 270, can, in one embodiment, be dependent on the context of the presented sub-sections 280. As an example, screen 200 can be a sub-screen with the title 210 of “TV Shows,” and each of the categories 220 can be different TV shows. Once a show was selected, such as by highlighting the appropriate selection 230 and then pressing the “OK” button as indicated, screen 270 can have the name of the TV show as its title 290 and each of the sub-selections 280 can be individual episodes of the TV show, presented in order from most recent to oldest. In such a case, the default sorting mechanism could be a mechanism that sorts the episodes based on age. Thus, the highlighted sorting mechanism 241 shown in FIG. 3 would be a “most recent” sorting mechanism, while the other sorting mechanisms 292 and 293 could be, for example, an “alphabetical” sorting mechanism, an “episode number” sorting mechanism, or other sorting mechanisms relevant to the selection of a particular episode of the selected TV show.

In addition to sorting options 240, screen 270 also displays a reverse sort option 296 that can be accessed via a special button, such as buttons 32 and 33 of remote control 30, and buttons 46 and 47 of remote control 40. As in screen 200, these buttons can be assigned specific functions via indicators at the bottom of the screen, such as indicator 295, which, like indicator 261 of screen 200, specifies the button to be used to select a prior screen. Screen 270 further illustrates the assigning of a reverse sorting feature to a special button via the indicator 296.

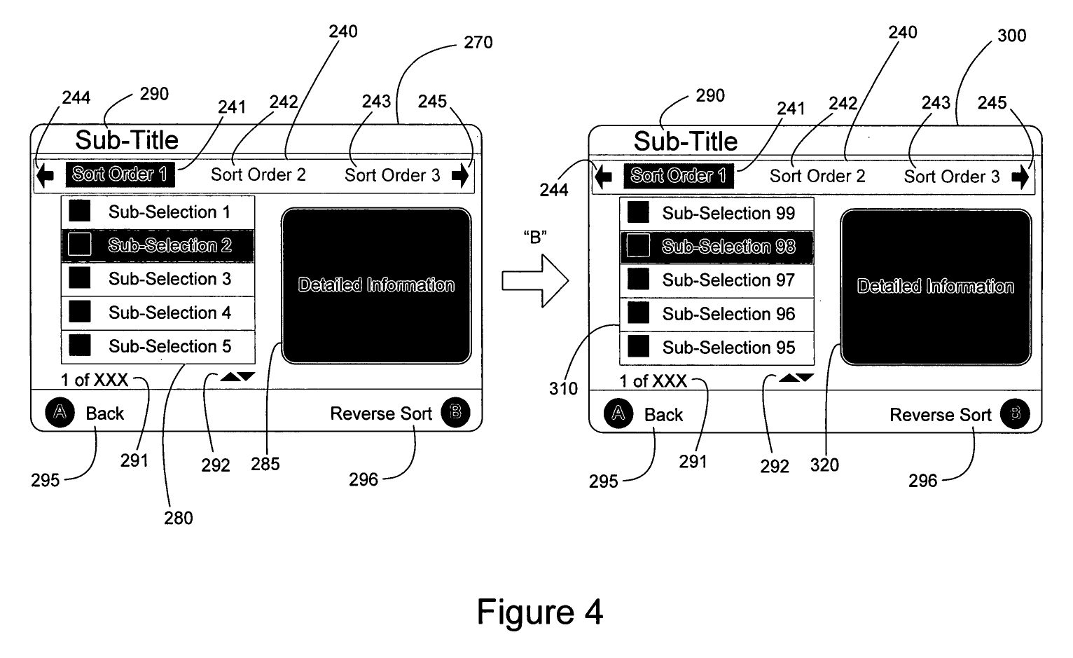

Turning to FIG. 4, the reverse sort feature is illustrated with respect to screen 270, described above, and screen 300. Specifically, the selection of the reverse sort option, in the manner specified by indicator 296, causes the sub-selections 280 to be displayed in a last-to-first order given the selected sorting mechanism 241. Thus, as shown, the selection of the “B” button from screen 270 results in the display of screen 300 whereby all of the elements remain unchanged from screen 200, except that sub-selections 310 are in a reversed order from sub-selections 280 and, consequently, a different sub-selection is selected, resulting in a new detailed information section 320. More precisely, the selection of the reverse sort option at screen 270 did not result in a new “screen,” as that term was defined previously, but rather resulted in a modified display of screen 270 which, for clarity is numbered 300 and referred to herein as screen 300.

As can be seen, the selection of the reverse sort option did not change the sorting mechanism selected. Consequently, the reverse sorting option can be used when a proper sorting mechanism has already been selected for the user's purposes, but the selection the user desires is located more than halfway through the sorted list of selections. For example, if the user sought to select a movie whose title the user already knew, the selected category could specify “Movies” and the selected sorting mechanism 241 could be an alphabetical sort. However, if the movie the user sought to select had a title that began with the letter “Z” , the user would still be forced to scroll through substantially all of the sub-selections 280. This is especially true if the user did not know any other relevant information about the movie, such that the user could select another sorting mechanism. In such a case, selection of the reverse sort option resorts the sub-selections into the order illustrated by selections 310, enabling the user to quickly reach sub-selections located more than halfway through the list of sub-selections as originally sorted.

As indicated previously, each of the selections 230 can have a default sorting mechanism for the sub-selections 280.

Depending on the user's knowledge and desires, however, the default sorting mechanism may not be the most relevant sorting mechanism to aid the user in identifying the entertainment they seek. For example, if the user is searching for movies directed by a particular director, listing all of the available movies by title, or by the date they were released will likely not aid the user. Similarly, even if the user does know the title of the movie, it may be far easier for the user to identify and select the movie from a much shorter list, such as, for example, if the user also knew the director of the movie.

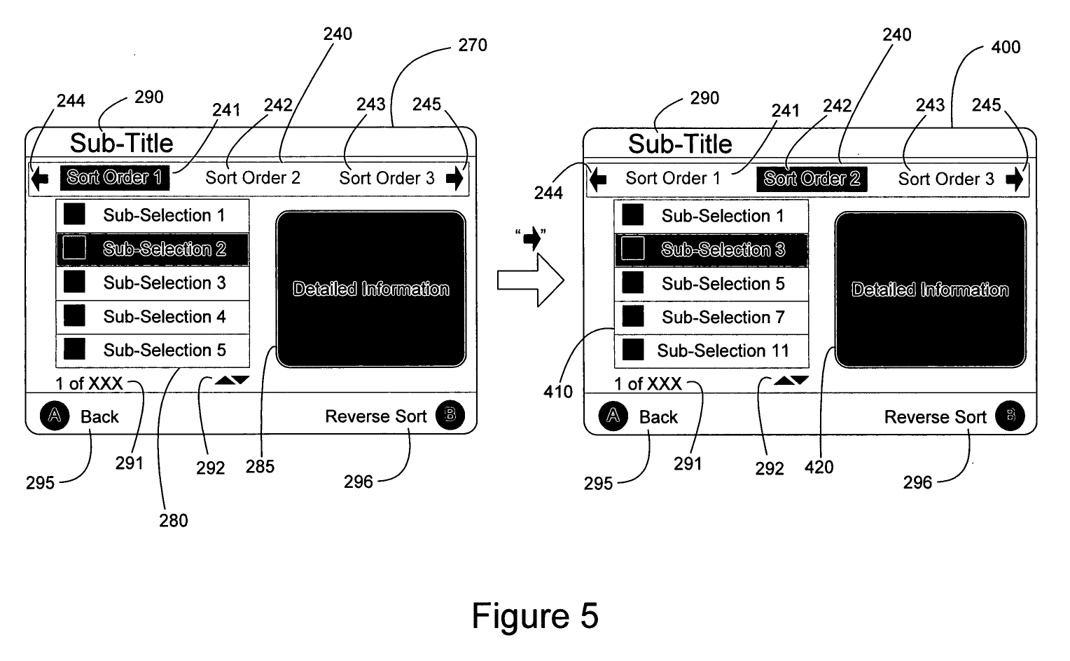

FIG. 5 illustrates one example of changing the sorting mechanism without requiring the user to select a new screen. As shown in FIG. 5, the input of the right arrow key, as indicated in the figure, results in a change of the selected sorting mechanism from mechanism 241 to mechanism 242 as shown in screens 270 and 400, respectively. As previously described, the sort selection indicator 245 specifies the button for selecting the sorting mechanism 242 to the right of the currently selected sorting mechanism 241 within the list of sorting mechanisms 240. Once a new sorting mechanism is selected, the list of sub-selections 280 is likewise changed to the list of sub-selections 410 reflecting the selection of sorting mechanism 242 instead of sorting mechanism 241. And, as with FIG. 4, screen 400 is not intended to represent a different “screen,” as that term is defined herein, from screen 270, but is instead intended to represent a mere redrawing of the screen 270, and the identifier 400 is applied to distinguish the redrawn screen from the original screen. Put differently, the appropriate user input, as identified by sort selection indicators 244 and 245, enables the user to resort the sub-selections 280 without generating or selecting a new screen.

In one embodiment, the identified sorting mechanisms 240 comprise a scrolling list such that only a few of the possible sorting mechanisms 240 are displayed at any given time. In an alternative embodiment, the identified sorting mechanisms 240 comprise a circular list such that only a single button can be used to select any of the sorting mechanisms 240. In a still further embodiment, the sorting mechanisms listed are tailored to the selections, such as sub-selections 280, that are being sorted. For example, a listing of episodes of a TV show may not need to offer a sorting mechanism based on the producer since the producer for substantially all, if not all, of the episodes of a given TV show will likely be the same. Similarly, a listing of movies may be usefully sorted via a sorting mechanism based on the length of a movie, enabling the user to select movies based on the amount of free time they have available, while such a sorting mechanism may not be useful for TV show episodes, as substantially all, if not all of the episodes of a TV show are the same length.

The combination of the selection of sorting mechanisms and reversing the sorting order, all from within the same screen, provides the user of a computing device 10 an efficient and sophisticated mechanism of selecting from among a myriad of choices without requiring the computing device 10 to display anything more than a limited interface designed to be perceived and understood at a distance. For example, if the user was looking for a long movie to watch while they were ill, they could just select the “Movies” category, choose a selection, such as “Newly Released,” “Top Downloads” or other analogous movie selections, and then sort the presented sub-selections 280 in an appropriate order. Specifically, the user could simply alter the sorting mechanism via the buttons, or other user input elements, identified by the selection indicator 244 or 245 until a “movie length” sorting mechanism was selected. Subsequently, again without leaving the current screen, the user could select a reverse sort, via the button or other user input element specified by the selection indicator 296, thereby resorting the movies by movie length in order of longest to shortest. If the user changed their mind and wanted a TV show instead, selecting the “back” button, or other user input element specified by the selection indicator 295, would undo the selection of the “Movies” category and enable the user to select a different category.

As can be seen from the above descriptions, a limited interface designed for distance viewing, can provide a sophisticated mechanism for selecting from among a myriad of choices by enabling the user to change the sorting mechanisms used to sort the choices and by enabling the user to reverse the order in which the choices are sorted, all from a single screen. In view of the many possible variations of the subject matter described herein, we claim as our invention all such embodiments as may come within the scope of the following claims and equivalents thereto.

We claim:

1. One or more computer-readable media comprising computer-executable instructions for providing sorting mechanisms on a limited interface presented via a display device to a user located at a distance from the display device, the computer-executable instructions directed to steps comprising:
generating a screen of the limited interface;
generating, as part of the screen, a sequence of selections;
generating, as part of the screen, an indication of at least two user-selectable sorting mechanisms applicable to the selections;
generating, as part of the screen, an indication of a user-selectable reverse sorting option applicable to the selections; and
responding to user input selecting one of the at least two sorting mechanisms or the reverse sorting option by re-sequencing the selections in a manner consistent with the user input and regenerating, as part of the same screen, the sequence of selections so as to conform to the re-sequencing.

2. The computer-readable media of claim 1, wherein the user input selecting one of the at least two sorting mechanisms comprises horizontal directional input from a remote control.

3. The computer-readable media of claim 1, wherein the user input selecting the reverse sorting option is generated by a user input element on a remote control assigned by the indication of the user-selectable reverse sorting option.

4. The computer-readable media of claim 1, wherein the indication of the at least two user-selectable sorting mechanisms comprises an indication of the user input element to be used to select among the at least two user-selectable sorting mechanisms.

5. The computer-readable media of claim 1, wherein the indication of the user-selectable reverse sorting option comprises an indication of the user input element to be used to select among the reverse sorting option.

6. The computer-readable media of claim 1 comprising further computer-executable instructions directed to obtaining, from a server, at least a subset of the sequence of selections.

7. The computer-readable media of claim 6, wherein the responding to user input further comprises obtaining, from the server, at least a second subset of the sequence of selections conforming to the re-sequencing.

8. The computer-readable media of claim 1, wherein the computer-executable instructions directed to the generating the sequence of selections further comprise computer-executable instructions directed to selecting a default sorting mechanism applicable to the selections.

9. The computer-readable media of claim 1, wherein the default sorting mechanism conforms with a category for which the sequence of selections is being generated.

10. A computing device for providing entertainment to a user via a display located at a distance from the user such that the user is not expected to be able to meaningfully perceive more than a limited interface, the computing device comprising:
a display output for generating a screen of the limited interface, the screen comprising a sequence of selections, an indication of at least two user-selectable sorting mechanisms applicable to the selections, and an indication of a user-selectable reverse sorting option applicable to the selections;
a remote control input for receiving user input selecting one of the at least two sorting mechanisms or the reverse sorting option; and
one or more processing units for responding to the user input by re-sequencing the selections in a manner consistent with the user input and regenerating, as part of the same screen, the sequence of selections so as to conform to the re-sequencing.

11. The computing device of claim 10 further comprising a remote control comprising one or more horizontal directional input elements used to generate the user input selecting one of the at least two sorting mechanisms.

12. The computing device of claim 10 further comprising a remote control comprising a control pad and no more than nine additional input elements, including one used to generate the user input selecting the reverse sorting option.

13. The computing device of claim 10 further comprising a network interface connected to a server for obtaining at least a subset of the sequence of selections.

14. The computing device of claim 13, wherein the re-sequencing comprises obtaining, from the server, at least a second subset of the sequence of selections conforming to the re-sequencing.

15. A method of providing access to sorting mechanisms on a limited interface presented via a display device to a user located at a distance from the display device, the comprising the steps of:
generating a screen of the limited interface;
generating, as part of the screen, a sequence of selections;
generating, as part of the screen, an indication of at least two user-selectable sorting mechanisms applicable to the selections;
generating, as part of the screen, an indication of a user-selectable reverse sorting option applicable to the selections; and
responding to user input selecting one of the at least two sorting mechanisms or the reverse sorting option by re-sequencing the selections in a manner consistent with the user input and regenerating, as part of the same screen, the sequence of selections so as to conform to the re-sequencing.

16. The method of claim 15, wherein the user input selecting one of the at least two sorting mechanisms comprises horizontal directional input from a remote control.

17. The method of claim 15, wherein the user input selecting the reverse sorting option is generated by a user input element on a remote control assigned by the indication of the user-selectable reverse sorting option.

18. The method of claim 15 further comprising the steps of obtaining, from a server, at least a subset of the sequence of selections.

19. The method of claim 18, wherein the responding to user input further comprises obtaining, from the server, at least a second subset of the sequence of selections conforming to the re-sequencing.

20. The method of claim 15, wherein the generating the sequence of selections further comprises selecting a default sorting mechanism applicable to the selections.
